(19) United States
(12) Patent Application Publication
(10) Pub. No.: US 2009/0233111 A1
(43) Pub. Date: Sep. 17, 2009

(54) Thermal Barrier Coating System

(76) Inventor: Thomas Uihlein, Dachau (DE)

Correspondence Address: FASSE PATENT ATTORNEYS, P.A., P.O. BOX 726, HAMPDEN, ME, 04444-0726, US

(21) Appl. No.: 11/989,374

(22) PCT Filed: Aug. 4, 2006
(86) PCT No.: PCT/DE2006/001359

§ 371 Date: Jan. 24, 2008

(30) Foreign Application Priority Data
Aug. 9, 2005 (DE) 102005037448.4

(51) Int. Cl. B32B 15/04; C23C 4/10

(52) U.S. Cl. 428/469

(57) ABSTRACT

The invention relates to a thermal insulation layer system (11) for structural components (10), in particular for metallic structural components of a gas turbine such as an aircraft engine, wherein the thermal insulation layer system (11) is formed of a thermal insulation base material. According to the invention, at least one aerogel is incorporated or encased or embedded in the thermal insulation base material.

The invention relates to a thermal barrier or insulation layer system for structural components, in particular for metallic structural components of a gas turbine such as an aircraft engine, according to the preamble of the claim 1. Furthermore the invention relates to a structural component with a thermal insulation layer system according to the preamble of the claim 11.

For protection against high temperatures and against hot gas corrosion, metallic structural components of a gas turbine are provided with thermal insulation layers. Thus, for example, the DE 100 08 861 A1 shows a thermal insulation layer system for a metallic structural component, whereby the thermal insulation layer system consist of two layers, namely of an inner contact layer and an outer cover layer. The inner contact layer is located between an adhesion promoting layer and the outer cover layer, whereby the adhesion promoting layer is applied on the structural component. According to the DE 100 08 861 A1, the inner contact layer of the thermal insulation layer system consists entirely or predominantly of zirconium oxide partially stabilized with yttrium oxide (Y₂O₃) or of a glass-metal-composite material, the outer cover layer consists of fully stabilized cubic zirconium oxide.

Further thermal insulation layer systems are known from the DE 197 43 579 C2 and from the DE 198 07 163 C1. The DE 197 43 579 C2 discloses a thermal insulation layer system of a ceramic thermal insulation base material, whereby the thermal insulation base material is applied by thermal spraying onto a component surface of a metallic structural component. The DE 198 07 163 C1 discloses a special thermal insulation base material for a thermal insulation layer system.

The thermal insulation layer systems that are known from the prior art, which are produced from the known thermal insulation base materials, comprise a thermal conductivity on the order of magnitude between 1 and 2 W/Km. Thereby the maximum thermal insulation of the thermal insulation layer systems known from the prior art is defined.

Beginning from this as a starting point, the problem underlying the present invention is to provide a novel thermal insulation layer system for structural components, in particular for metallic structural components of a gas turbine such as an aircraft engine, as well as a corresponding structural component.

This problem is solved by a thermal insulation layer system according to claim 1. According to the invention, at least one aerogel is incorporated or encased or embedded in the thermal insulation base material.

In the sense of the present invention, a thermal insulation layer system of a thermal insulation base material is proposed, whereby at least one aerogel is incorporated or encased or embedded in the thermal insulation base material. Aerogels involve extremely porous as well as very light materials, that can be produced practically of each or every metal oxide, of metal oxide mixtures or any other materials. Through the incorporation or encasement or embedding of at least one aerogel in the thermal insulation base material of a thermal insulation layer system, the thermal conductivity can be strongly reduced, preferably to an order of magnitude between 0.01 and 0.02 W/Km. Thus, with the inventive thermal insulation layer system, a significantly higher thermal insulation can be realized in comparison to thermal insulation layer systems known from the prior art. Due to the feature that the aerogels are incorporated or encased or embedded in a thermal insulation base material, the inventive thermal insulation layer system has an abrasion resistance or wear resistance that is comparable to the thermal insulation layer systems known from the prior art.

Preferably, the or each aerogel incorporated or encased or embedded in the thermal insulation base material is embodied as an oxidic aerogel and is formed of a material corresponding to the thermal insulation base material.

According to a first advantageous further embodiment of the invention, the thermal insulation layer system is embodied as a single layer system, whereby the single layer thereof is formed of the thermal insulation base material and the or every aerogel incorporated in the thermal insulation base material.

According to an alternative second advantageous further embodiment of the invention, the thermal insulation layer system is embodied as a multi-layer system, whereby a layer that is formed of the thermal insulation base material and the or every aerogel incorporated therein is respectively positioned between two layers that are formed exclusively of the thermal insulation base material.

Preferred further embodiments of the invention arise from the dependent claims and the following description. Example embodiments of the invention are explained more closely in connection with the drawing, without being limited hereto. Therein:

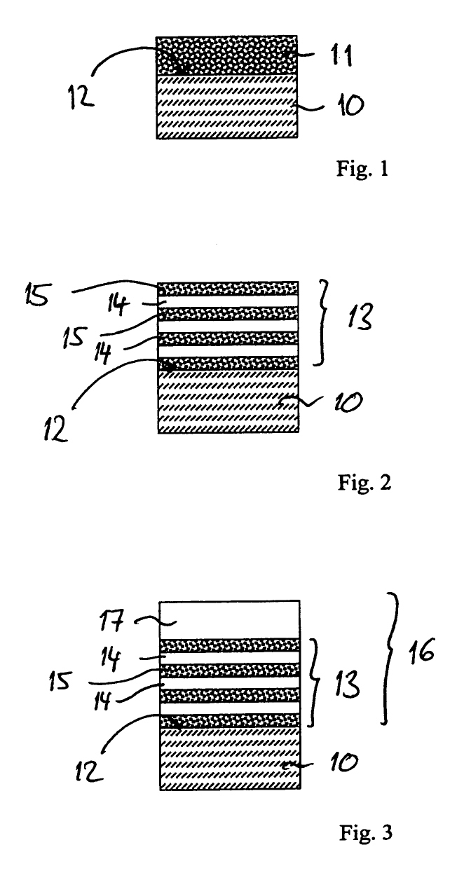

FIG. 1 shows a strongly schematized cross-section through a thermal insulation layer system according to a first example embodiment of the invention;

FIG. 2 shows a strongly schematized cross-section through a thermal insulation layer system according to a second example embodiment of the invention; and

FIG. 3 shows a strongly schematized cross-section through a thermal insulation layer system according to a third example embodiment of the invention.

In the following, the present invention will be described in greater detail with reference to FIGS. 1 to 3.

FIG. 1 shows a first example embodiment of the present invention in a strongly schematized illustration, whereby an inventive thermal insulation layer system 11 is applied onto a structural component 10. The structural component 10 involves preferably a metallic structural component of a gas turbine, in particular a metallic structural component of an aircraft engine.

The inventive thermal insulation layer system 11 is applied onto a surface 12 of the structural component 10, whereby the thermal insulation layer system 11 of the example embodiment of FIG. 1 is embodied as a single layer system. The thermal insulation layer system 11 of FIG. 1 thus has a single layer, whereby the layer is formed of a thermal insulation base material and of at least one aerogel incorporated or encased or embedded in the thermal insulation base material.

The thermal insulation base material of the thermal insulation layer system 11 can involve all thermal insulation base materials known from the field of gas turbine construction or aircraft engine construction, thus for example aluminum oxide, yttrium stabilized zirconium oxide, or also lanthanum hexaaluminate. At least one aerogel, preferably an oxidic aerogel, is incorporated in such a thermal insulation base material. Preferably the or each aerogel is formed of a material that is adapted or matched to the thermal insulation base material. When the thermal insulation base material is yttrium stabilized zirconium oxide, then the aerogel can be formed of zirconium oxide. When the thermal insulation base material is lanthanum hexaaluminate, then the aerogel is preferably formed of lanthanum hexaaluminate.

At this point it is mentioned that aerogels involve extremely porous and very light materials. Aerogels can be produced nearly of every or any metal oxide or of metal oxide mixtures or also of other materials. Aerogels have a pore volume between 85% and 99%. Such aerogels are preferably produced in that a starting material, for example a metal oxide, is dissolved in a solvent agent, whereby next a hydrolysis occurs by addition of water. Then an aggregation of hydrolyzed monomers to colloidal particles occurs, whereby thereafter a gelation is carried out, by which the colloidal particles form a three-dimensional network. Following the gelation, a drying occurs through removal of the liquid phases, whereby then an aerogel is present as a result.

FIG. 2 shows a second example embodiment of the present invention, whereby in the example embodiment of FIG. 2 once again a thermal insulation layer system 13 is applied onto the component surface 12 of a preferably metallic structural component 10. The thermal insulation layer system 13 of the example embodiment of FIG. 2 is embodied as a multi-layer system and thus has several layers. First layers 14 are formed exclusively of the thermal insulation base material, whereas in contrast second layers 15 consist of the thermal insulation base material and at least one aerogel incorporated in the thermal insulation base material. In that regard, respectively one layer 15 of the thermal insulation base material with the aerogel incorporated therein is arranged between two layers 14 of the thermal insulation base material. With such a several-layer system or multi-layer system, the thermal blocking effect can again further be optimized relative to the example embodiment of FIG. 1. It is mentioned that the layers 15 with the incorporated aerogel can be embodied considerably thinner than the layers 14 that are formed simply of the thermal insulation base material.

A further example embodiment of an inventive thermal insulation layer system 16 is shown by FIG. 3, whereby the thermal insulation layer system 16 of FIG. 3 is distinguished from the thermal insulation layer system 13 of FIG. 2 simply in that a layer 17 of the thermal insulation base material is applied onto the outer layer 15 that is formed of the thermal insulation base material and the aerogel incorporated in the thermal insulation base material. In the example embodiment of FIG. 3, the thermal insulation layer system 16 is thus outwardly terminated or enclosed by a layer 17 of the thermal insulation base material. The abrasion resistance or wear resistance of the thermal insulation layer system 16 can be increased by the outer layer 17.

For producing the inventive thermal insulation layer system, one proceeds such that a powder of thermal insulation base material are mixed with particles of aerogel, whereby then this mixture is used for applying the thermal insulation layer system of FIG. 1 or the layers 15 of the thermal insulation layer systems 13 and 16 of the example embodiments according to FIGS. 2 and 3 onto the structural component 10 through a drossing process or sol-gel process or through thermal spraying.

An adhesion promoting layer can respectively be arranged between the thermal insulation layer systems 11, 13 and 16 of the example embodiments according to FIGS. 1 to 3 and the structural component 10. Such adhesion promoting layers are preferably formed of a MCrAlY material.

Several different aerogels can also be incorporated or encased or embedded in the thermal insulation base material of the inventive thermal insulation layer systems.

The inventive thermal insulation layer system preferably is utilized for metallic structural components of a gas turbine, in particular an aircraft engine.

1. Thermal insulation layer system for structural components, in particular for metallic structural components of a gas turbine such as an aircraft engine, whereby the same is formed of a thermal insulation base material, characterized in that at least one aerogel is incorporated or encased or embedded in the thermal insulation base material.

2. Thermal insulation layer system according to claim 1, characterized in that the or each aerogel is embodied as an oxidic aerogel.

3-12. (canceled)

13. Thermal insulation layer system according to claim 1, characterized in that the aerogel is formed of zirconium oxide.

14. Thermal insulation layer system according to claim 1, characterized in that the aerogel is formed of lanthanum hexaaluminate.

15. Thermal insulation layer system according to claim 1, characterized in that the aerogel is formed of a material corresponding to the thermal insulation base material.

16. Thermal insulation layer system according to claim 1, characterized in that the thermal insulation base material is aluminum oxide.

17. Thermal insulation layer system according to claim 1, characterized in that the thermal insulation base material is preferably yttrium stabilized zirconium oxide.

18. Thermal insulation layer system according to claim 1, characterized in that the thermal insulation base material is lanthanum hexaaluminate.

19. Thermal insulation layer system according to claim 1, embodied as a single layer system, whereby the single layer (11) thereof is formed of the thermal insulation base material and the or each aerogel incorporated in the thermal insulation base material.

20. Thermal insulation layer system according to claim 1, embodied as a multi-layer system, whereby one layer (14) that is formed of the thermal insulation base material and the or each aerogel incorporated therein is positioned respectively between two layers (15) that are formed exclusively of the thermal insulation base material.

21. Structural component arrangement comprising a structural component of a gas turbine having a metallic component surface, and a thermal insulation layer system (11, 13, 16) according to claim 1 applied onto the metallic component surface (12).

22. Structural component arrangement according to claim 21, further comprising at least one adhesion promoting layer positioned between the component surface (12) and the thermal insulation layer system (11, 13, 16).
